(19) United States
(12) Patent Application Publication
(10) Pub. No.: US 2008/0204976 A1
(43) Pub. Date: Aug. 28, 2008

(54) Fastening Arrangement

(75) Inventors: Harri Mattlar, Iskmo (FI); Rainer Kolmonen, Laihia (FI); Juho Salo, Vaasa (FI); Osmo Pikkala, Sundom (FI); Aki Suutarinen, Vaasa (FI); Jarkko Alanen, Yliharma (FI); Risto Kajan, Vaasa (FI)

Correspondence Address: BUCHANAN, INGERSOLL & ROONEY PC, POST OFFICE BOX 1404, ALEXANDRIA, VA, 22313-1404, US

(73) Assignee: ABB OY, HELSINKI FINLAND (FI)

(21) Appl. No.: 10/586,250

(22) PCT Filed: Jan. 18, 2005
(86) PCT No.: PCT/FI2005/000027

§ 371 Date: Apr. 17, 2008

(30) Foreign Application Priority Data
Jan. 19, 2004 (FI) U20040016

(51) Int. Cl. H02B 1/04

(52) U.S. Cl. 361/673

(57) ABSTRACT

The invention relates to a fastening arrangement for fastening a switching device to a mounting tray, the fastening arrangement comprising a fastening point (12) formed in the switching device or the like, and a lug (10) to be fastened to the fastening point (12). The fastening point comprises at least three recesses (16) to receive the protrusion (24) in the lug (10) in such a way that the lug (10) is optionally lockable, when being fastened to the switching device, to different positions defined by the recesses (16), one of the positions being a substantially vertical position, another being a substantially horizontal position, and the rest being positions at an angle between these positions.

### BACKGROUND OF THE INVENTION

The invention relates to a fastening arrangement according to the preamble of claim 1, and particularly to a fastening arrangement for fastening a switching device or the like to a mounting tray, the fastening arrangement comprising a fastening point formed in the switching device or the like, and a lug to be fastened to the fastening point.

The switching devices according to prior art, particularly modular switching devices, or the like are fastened in place to the mounting tray by means of lugs. The lugs are fastened to the switching device or the like, and further to the mounting tray with screws or the like fastening means. The fastening point in the switching device is formed in such a way that the lug can be locked to the switching device either in the horizontal or vertical position. The horizontal position of the lug is used when the lug is fastened to the lateral outer edge of the switching device, whereas the vertical position is used when the lug is fastened to the upper and lower edges of the switching device.

A problem with the above-described arrangement is that when lugs are fastened in the vertical position to a modular switching device between the ends at the upper edge, the lugs coincide in line with the line terminals in the driver modules of the modular switching device, which line terminals protrude vertically upwards from the switching device, as do the lugs. The lugs being in line with the line terminals, it is very difficult to tighten a lug to the mounting tray, because a screwdriver or the like must be used in an oblique position. Further, it is not possible to optimize the space utilization of the mounting tray in an ideal way, because the lugs cannot be directed in a desired manner in all mounting situations.

### BRIEF DESCRIPTION OF THE INVENTION

An object of the invention is thus to provide a fastening arrangement for fastening a switching device or the like to a mounting tray in such a way that the above problems can be solved. The object of the invention is achieved with a fastening arrangement according to the characterizing part of claim 1, which is characterized in that the lug is substantially plate-like and comprises at least one protrusion, and the fastening point comprises at least three recesses to receive the protrusion in the lug in such a way that the lug is optionally lockable, when being fastened to the switching device or the like, to different positions defined by the recesses, one of the positions being a substantially vertical position, another being a substantially horizontal position, and the rest being positions at an angle between these positions.

Preferred embodiments of the invention are described in the dependent claims.

The invention is based on the idea that a modular switching device or the like is fastened to a mounting tray located in a switch cabinet, for example, by means of a lug. In the switching device, a fastening point is formed to which the lug is fastened. According to the present invention, the fastening point comprises at least three recesses which are capable of receiving a protrusion in the lug. By means of the recesses of the fastening point and the protrusions of the lugs, the lug, when being fastened to the switching device, can be optionally locked in a desired position. In addition to the substantially vertical and horizontal positions of the lug, the recesses define at least one lug position where the lug protrudes from the switching device obliquely upwards or downwards, for instance at an angle of 45 degrees.

An advantage of the arrangement according to the invention is that this third position, in which the lug protrudes from the switching device obliquely upwards or downwards, allows lugs to be fastened at a desired point on the mounting tray and thus also the space utilization of the mounting tray to be optimized. Furthermore, the fastening arrangement according to the invention makes it easier to tighten and fasten the lug attached to the switching device, and thus also the whole switching device, to the mounting tray, because when being directed for instance obliquely upwards at the upper edge of the switching device, the lugs can be positioned in line with the outer edges of different modules. Thus, the fastening points of the lugs, by which the lugs are fastened to the mounting tray, can be positioned staggered relative to the line terminals protruding upwards or downwards from the driver modules, whereby the line terminals do not complicate the fastening of the lugs and thus the switching device to the mounting tray. At the same time, the vertical and horizontal positions of the lugs can still be utilized at desired points.

### BRIEF DESCRIPTION OF THE FIGURES

The invention will now be described in greater detail in connection with preferred embodiments, with reference to the attached drawings, of which:

FIG. 1 shows an example of a modular switching device to be fastened to a mounting tray by means of lugs.

FIG. 2 shows a perspective view of a fastening point of an embodiment, to which the lug is to be fastened.

FIG. 3 shows a principled view of the fastening point of the embodiment of FIG. 2, to which the lug is to be fastened.

FIG. 4 shows an exemplary embodiment of a lug to be fastened to the fastening point of FIG. 3.

FIG. 5 shows a principled view of a fastening point of another embodiment, to which the lug is to be fastened.

FIGS. 6A and 6B show an exemplary embodiment of a lug to be fastened to the fastening point of FIG. 5.

### DETAILED DESCRIPTION OF THE INVENTION

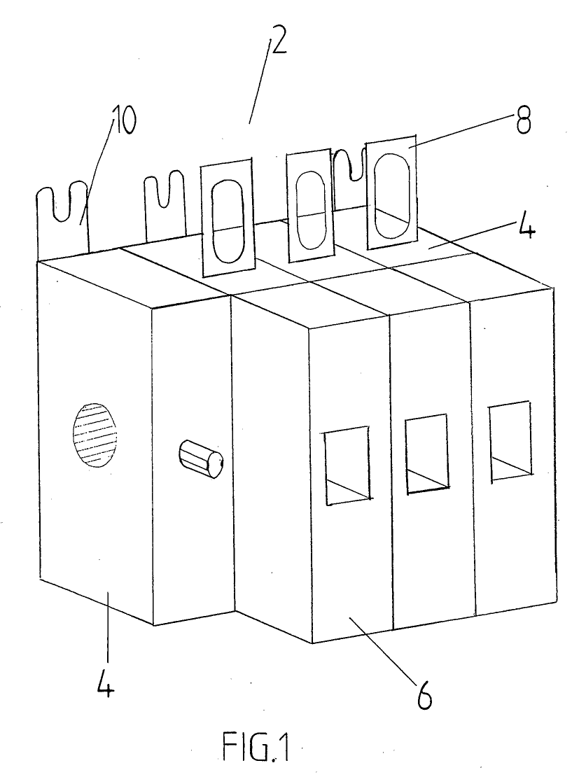

FIG. 1 shows an embodiment of a modular switching device 2 comprising driver modules 4 and pole cell modules 6, for example. According to FIG. 1, the driver modules 4 are provided with line terminals 8 that protrude from these driver modules 4 vertically upwards and/or downwards. Lugs 10 are fastened to such a switching device and further to a mounting tray to mount the switching device 2 in place. The lugs 10 protrude, in accordance with prior art, from the lateral outer edges of the switching device 2 substantially horizontally, and from the upper and lower outer edges substantially vertically. Hereby, the line terminals 8 and the lugs 10 coincide in line with each other as seen from the front of the switching device, which complicates, when mounting the switching device on the mounting tray, the tightening of the lugs with a screwdriver, for instance, because the tightening cannot be done perpendicularly, as would be preferable, due to the line terminals 8 being positioned in front of the lugs 10.

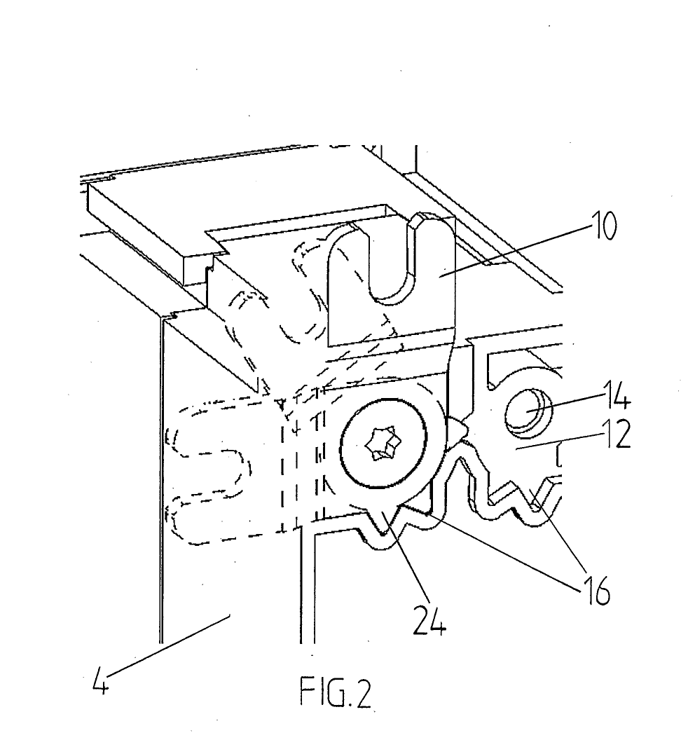

FIG. 2 shows a solution according to one embodiment for making the position of the lug 10 such that in mounting the switching device the tightening of the lug to the mounting tray is facilitated and the space utilization of the mounting tray can be optimized. In accordance with FIG. 2, the surface of the driver module or alternatively of another part of the modular switching device 2 is provided with one or more fastening points 12, to which the lug is fastened with a screw or the like fastening means. The fastening point 12 is embedded in such a way that when the lug 10 is tightened in place, the outer surface of the lug 10 becomes preferably positioned on the same plane as the outer surface of the driver module 4. The fastening point 12 formed by the embedding is provided with a hole 14 for fastening the lug 10.

In this embodiment, the fastening point 12 is positioned in an exemplary manner on the rear surface of the driver module 4, which becomes positioned against the mounting tray, but alternatively the fastening point 12 can be positioned in any part of the switching device 2 which becomes positioned substantially parallel to the mounting tray and against it. Further, the fastening point 12 can be positioned at a desired point on the rear surface of the driver module 4, and there may be more than one fastening point in the driver module 4, in which case they may be arranged in rows or positioned in another alternative way.

In accordance with FIG. 2, the outer edges of the fastening point 12, or of the embedding, are provided with recesses 16 that are on the same plane as the embedding and form thus dent-like extensions at the edges of the embedding. The shape of the embedding 12 can be selected freely as far as it is provided with clear recesses 16, the shape of which can also be selected freely. The recesses 16 may be wedge-shaped, rectangular or of any other shape.

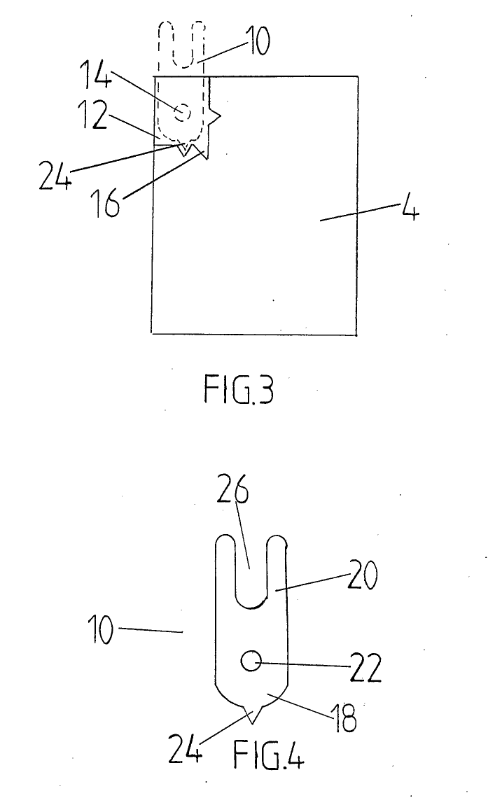

The embodiment of FIG. 2 is shown simplified in FIG. 3. In accordance with the invention, the lug 10 is positioned at the fastening point 12 in a desired position in such a way that a protrusion 24 in the lug becomes positioned in the recess 16 of the fastening point 12. Thus, the protrusion 24 of the lug and the recess 16 of the fastening point lock the lug 10 to a desired position. In accordance with FIG. 3, there can be three such positions, at least one of which locks the lug 10 to an angular position obliquely upwards or downwards.

FIG. 4, in turn, shows a plate-like lug 10 according to an embodiment of the present invention. The lug 10 is elongated and comprises a protrusion 24 and a hole 22 at its first end 18 to be positioned at the fastening point 12, and a slot 26 at its second end 20, by which the lug is fastened to the mounting tray of the switching device 2. The slot 26 is provided with a screw or the like fastening means, with which the lug 10 is fastened to the mounting tray of the switching device. The slot 26 can, if desired, be replaced with a hole, but using the slot 26 gives more latitude to the mounting of the switching device 2, because the screw can be placed at the desired point in the slot 26. The lug may also, if desired, comprise folds or waves, or it can be slightly bent, in which case it is not completely plate-like any more. The lug may also be rectangular, triangular or of any geometrical shape suitable for the purpose of use of the lug. Furthermore, the lug may comprise one or more protrusions 24, if required.

The recesses 16 and the protrusion 24 of the lug cooperate when the lug 10 is positioned in place at the fastening point 12. The recesses 16 are capable of receiving the protrusion 24, locking the lug to a given position. FIG. 3 shows a solution according to this embodiment, in which the lug 10 is positioned in place at the fastening point 12. In this figure, the lug 10 is positioned in the vertical position, the slot 26 protruding upwards, and in addition, the other possible positions of the lug 10 at the fastening point 12 are shown by broken lines. In accordance with FIG. 3, the fastening point 12 has three recesses 16, whereby the lug 10 also has three possible positions. In this embodiment, the recesses 16 and the protrusion 24 define a substantially vertical and a substantially horizontal position for the lug 10, as well as a position between these two, where the lug 10 protrudes obliquely upwards. Depending on the location of the fastening point 12, there may be several such positions between the vertical and horizontal positions, and alternatively the lug may protrude downwards as well. The positions can thus be selected according to particular needs, and also the length of the lug can be selected as desired, whereby the switching device can be fastened to the mounting tray at precisely the desired point, and the fastening point of the lug to the mounting tray can be selected in such a way that for instance the line terminals 8 do not hinder the tightening of the lugs.

In the embodiment according to FIGS. 2 and 3, the recess 16 defining the position of the lug 10 between the vertical and horizontal positions is placed in such a way that it locks the lug 10 to an upward-directed position at an angle of about 45°. Thus, the lug 10 is in a position where the fastening point of the lug to the mounting tray is in line with the outer edge of the module, whereby the slot 26 of the lug, i.e. the fastening point of the lug to the mounting tray, is staggered relative to the line terminals 8, the switching device being seen from the front. In other words, since the lugs are positioned staggered in spaces between the line terminals 8, there are no obstacles in front of the slots 26 of the lug 10 that would complicate the tightening of the lug to the mounting tray.

In the solution of FIGS. 2 and 3, the lug has three possible fastening positions to the driver module. By increasing the number of recesses 16 at the fastening point, the number of these fastening points can be increased. The recesses can also be positioned in a desired manner, whereby the lug can be directed to a position according to each particular need. By means of the recesses 16 and the protrusion 24, the lug 10 can be placed and fastened accurately to the desired and predetermined position in the switching device in such a way that it cannot move during the tightening and that all lugs are with certainty in the same position as accurately as possible.

The recesses can be formed at the fastening point also with strips that protrude outwards from the rear surface of the driver module, defining between them recesses into which the protrusions of the lugs can be fitted. In such a case, no embedding is needed for the rear surface, but the lug is positioned directly upon the rear surface.

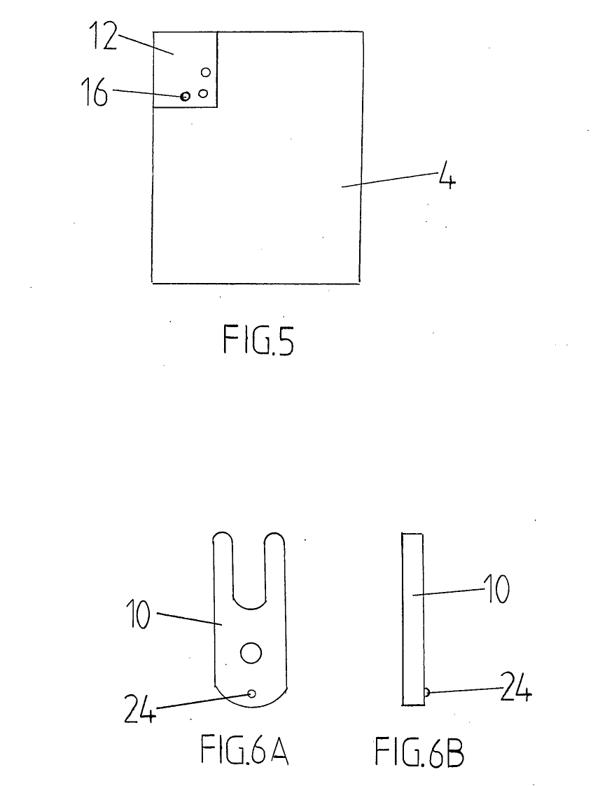

FIGS. 5 and 6A and 6B show another embodiment of the invention. In this embodiment, the recesses 16 formed at the fastening point 12 are depressions or “pits” formed on the surface of the fastening point. Correspondingly, the protrusions 24 of the lug 10 protrude outwards from the surface of the lug 10, and correspond, as regards their shape, to the recesses 16 similar to the depressions of the fastening point in accordance with FIGS. 6A and 6B. In this embodiment, the position of the lugs can be selected in the same way as in the above-described embodiment. The only difference is the different shaping and positioning of the recesses and protrusions.

In the fastening arrangement of a switching device or the like according to the invention, the basic idea is thus that the lug can be positioned not only in the vertical and horizontal positions but also in at least one angular position defined by the recesses and protrusions, whereby the lug protrudes from the switching device obliquely upwards or downwards. Positioning of the switching device or the like is also facilitated when the hole by which the lug is fastened to the mounting tray is replaced by a slot in accordance with FIGS. 1 to 6. Thus, the fastening screws with which the lugs and thus the switching device are fastened to the mounting tray are partly fastened to the mounting tray in advance. After that, the switching device is lifted to be supported by the lugs protruding downwards from it by passing the screws partly fastened to the mounting tray into the slots of the lugs protruding downwards from the switch, whereby these lugs support the switching device and facilitate the fastening and tightening of the switching device to the mounting tray.

It will be obvious to a person skilled in the art that as the technology advances, the basic idea of the invention can be implemented in a plurality of ways. The invention and its embodiments are thus not restricted to the above examples but can vary within the scope of the claims.

1. A fastening arrangement for fastening a switching device or the like to a mounting tray, the fastening arrangement comprising a fastening point formed in the switching device or the like, and a lug to be fastened to the fastening point, wherein the lug is substantially plate-like and comprises at least one protrusion, and the fastening point comprises at least three recesses to receive the protrusion in the lug in such a way that the lug is optionally lockable, when being fastened to the switching device or the like, to different positions defined by the recesses, one of the positions being a substantially vertical position, another being a substantially horizontal position, and the rest being positions at an angle between these positions.

2. A fastening arrangement according to claim 1, wherein the recess defining the position between the horizontal and vertical positions of the lug is positioned to lock the lug to a position directed upwards or downwards.

3. A fastening arrangement according to claim 1, wherein the recess defining the position between the horizontal and vertical positions of the lug is positioned to lock the lug to a position directed upwards and downwards at an angle of 45°.

4. A fastening arrangement according to claim 1, wherein the switching device is a modular switching device in which the recess defining the position between the horizontal and vertical positions of the lug is positioned to lock the lug in a position where the fastening point of the lug to the mounting tray is in line with the outer edge of a module.

5. A fastening arrangement according to claim 1, wherein the fastening point has at least four recesses, whereby the lug is lockable to at least two positions between the vertical and horizontal positions of the lug.

6. A fastening arrangement according to claim 1, wherein the protrusion of the lug is substantially on the same plane as the surface of the lug.

7. A fastening arrangement according to claim 1, wherein the protrusion of the lug protrudes outwards from the surface of the lug.

8. A fastening arrangement according to claim 1, wherein the lug has two or more protrusions.

9. A fastening arrangement according to claim 1, wherein both the lug and the fastening point of the switching device or the like comprise a hole for fastening the lug to the switching device or the like.

10. A fastening arrangement according to claim 1, wherein the lug further comprises a second hole for fastening the lug and thus also the switching device or the like to the mounting tray.

11. A fastening arrangement according to claim 1, wherein the lug further comprises a slot for fastening the lug and thus also the switching device or the like to the mounting tray.

12. A fastening arrangement according to claim 2, wherein the recess defining the position between the horizontal and vertical positions of the lug is positioned to lock the lug to a position directed upwards and downwards at an angle of 45°.

13. A fastening arrangement according to claim 12, wherein the switching device is a modular switching device in which the recess defining the position between the horizontal and vertical positions of the lug is positioned to lock the lug in a position where the fastening point of the lug to the mounting tray is in line with the outer edge of a module.

14. A fastening arrangement according to claim 13, wherein the fastening point has at least four recesses, whereby the lug is lockable to at least two positions between the vertical and horizontal positions of the lug.

15. A fastening arrangement according to claim 14, wherein the protrusion of the lug is substantially on the same plane as the surface of the lug.

16. A fastening arrangement according to claim 15, wherein the protrusion of the lug protrudes outwards from the surface of the lug.

17. A fastening arrangement according to claim 16, wherein the lug has two or more protrusions.

18. A fastening arrangement according to claim 17, wherein both the lug and the fastening point of the switching device or the like comprise a hole for fastening the lug to the switching device or the like.

19. A fastening arrangement according to claim 18, wherein the lug further comprises a second hole for fastening the lug and thus also the switching device or the like to the mounting tray.

20. A fastening arrangement according to claim 19, wherein the lug further comprises a slot for fastening the lug and thus also the switching device or the like to the mounting tray.
